(19) United States
(12) Patent Application Publication
(10) Pub. No.: US 2017/0171298 A1
(43) Pub. Date: Jun. 15, 2017

(54) ENHANCED VIRTUAL SWITCH FOR NETWORK FUNCTION VIRTUALIZATION

(71) Applicant: Intel Corporation, Santa Clara, CA (US)

(72) Inventor: Krishnamurthy Krishna Jambur Sathyanarayana, Shannon (IE)

(21) Appl. No.: 14/963,522

(22) Filed: Dec. 9, 2015

(51) Int. Cl. H04L 29/08

(52) U.S. Cl. CPC H04L 67/10

(57) ABSTRACT

Some embodiments include apparatuses having a circuit and a memory. The circuit can receive information for transmitting to at least one of a first virtual machine and a second virtual machine through a virtual switch. The memory can store configuration information set up by the virtual switch to allow the first virtual machine to bypass the virtual switch and communicate with at least one of the second virtual machine and a host.

### TECHNICAL FIELD

Embodiments described herein pertain to virtual communication network infrastructures. Some embodiments relate to software virtual switches.

### BACKGROUND

A virtual switch (or vSwitch) is a software application used in many virtual communication environments. A virtual switch allows communication among virtual machines or among virtual machines and physical components in a system or network. Many conventional virtual switches exist. However, some of these conventional virtual switches may have limitations such as high resource usage, lack of flexibility and scalability, and susceptibility to indeterministic performance. These limitations may render some conventional virtual switches unsuitable for some virtual communication network infrastructures.

### BRIEF DESCRIPTION OF THE DRAWINGS

FIG. 1 shows a block diagram of an apparatus in the form of a system including virtual switch-based communication paths, according to some embodiments described herein.

FIG. 2 is a diagram showing an algorithm associated with communication flow and creation of communication paths in the system of FIG. 1, according to some embodiments described herein.

FIG. 3 shows a block diagram of the system of FIG. 1 including an example of reduced communication paths, according to some embodiments described herein.

### DETAILED DESCRIPTION

The techniques described herein relate to a virtual switch-based communication system. The system includes a virtual switch that can be an implementation of Layer 2 or Layer 3 (or a combination of both) of the Open System Interconnection model (OSI). Besides the virtual switch, other entities in the infrastructure of the system include platform hardware, a host, and virtual machines. Many communication paths among these entities in the system go through the virtual switch. In the techniques described herein, the virtual switch and at least some of other entities in the system are configured with enhanced intelligence. Such configuration allows the virtual switch and the other entities in the system to choose or to create optimal communication paths among the entities. The communication paths can be chosen or created based on communication flow (e.g., traffic flow) parameters, such as priority, latency, service level agreement (SLA) or cost of computing (or both) associated with virtual machines used in the system, or other communication flow parameters. The optimal communication paths may reduce or eliminate some functions involved in normal operations of the virtual switch. Such functions may include receiving and transmitting of information (e.g., packets), software hashing, and table look-ups. Reducing or eliminating such functions may improve (e.g., reduce) computing cycles, cache thrashing, data copying, and complexity of software. Thus, higher throughput data flow may be achieved.

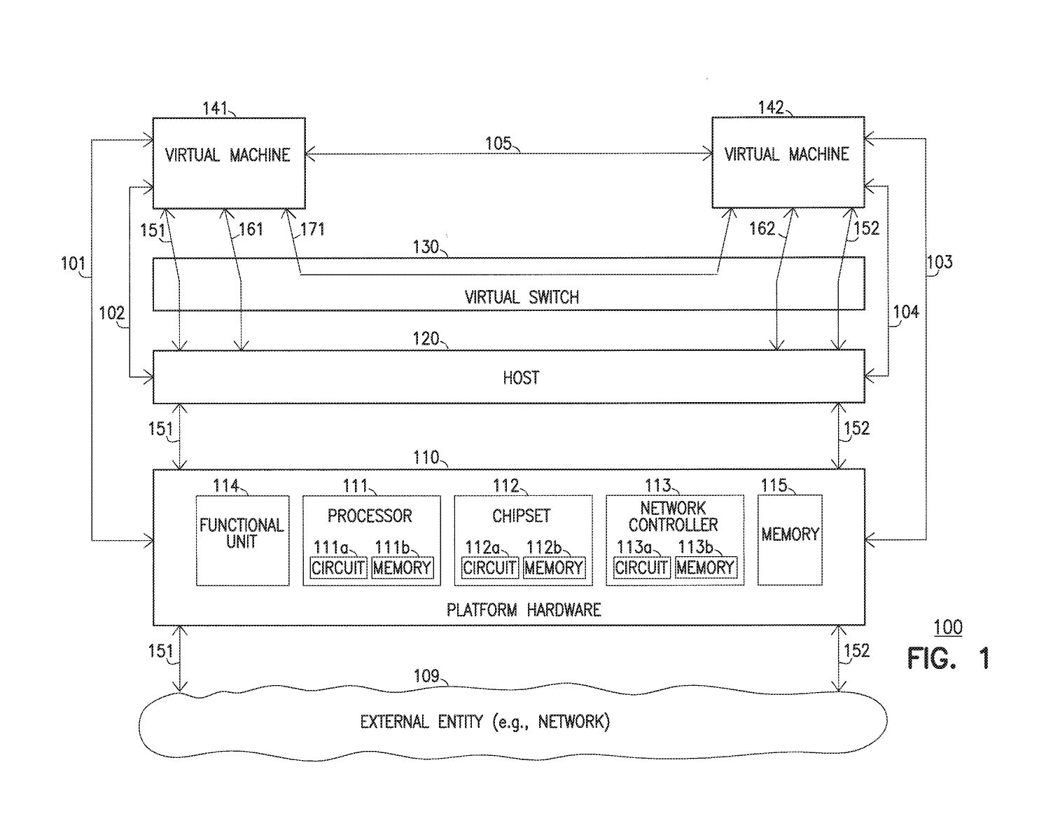

FIG. 1 shows a block diagram of an apparatus in the form of a system 100 including virtual switch-based communication paths, according to some embodiments described herein. System 100 includes platform hardware 110, a host 120, a virtual switch 130, and virtual machines 141 and 142. FIG. 1 shows two virtual machines 141 and 142 as an example. The number of virtual machines can vary. Platform hardware 110 can communicate with an entity 109. Entity 109 can include an external entity (e.g., a network or components of a network).

Platform hardware 110 can include or be included in mobile devices (e.g., cellular phones and tablets), personal computers (e.g., desktops and laptops), set-top boxes, televisions, server computers, mainframes, and other electronic devices or systems. As shown in FIG. 1, platform hardware 110 can include at least one processor (e.g., a central processing unit (CPU) 111, a chipset 112, a network controller 113, a functional unit 114, and a memory 115.

Processor 111 can include a general-purpose processor or an application specific integrated circuit (ASIC). Processor 111 can include a circuit 111a and a memory 111b. Chipset 112 can include a circuit 112a and a memory 112b. Chipset 112 can include other components (e.g., a processing unit) to perform operations such as input/output (I/O) and other processing operations. Network controller 113 can include a circuit 113a and a memory 113b and other components (e.g., a processing unit) to perform operations such as allowing platform hardware 110 to communicate with a network (e.g., the Internet, an Ethernet-based network, a wireless network, or other networks). Network controller 113 can be a network adapter (e.g., network interface card (NIC)). Functional unit 114 can include components (e.g., an accelerator) that can perform functions, such as encryption, decryption, compression, L1 modulation and demodulation (e.g., Fast Fourier Transform (FFT), inverse FFT, etc.), or other functions. In the description herein, a circuit (e.g., circuit 111a, 112a, or 113a) can include circuit components that can transmit (e.g., receive and send) information (e.g., data). A circuit in the description herein can also include or can be general purpose processor running code read from memory.

Memory 115 can include non-volatile memory, volatile memory, or a combination of both. Memory 115 can include any type of memory, such as semiconductor-based storage media, non-semiconductor-based storage media, magnetic (e.g., disc) storage media, optical storage media, or other types of non-transitory computer readable storage media. The non-transitory computer readable storage media can contain instructions, which cause at least one component of system 100 (e.g., one or more of processor 111, chipset 112, and network controller 113) to perform methods (e.g., operations associated with system 100) described herein.

Additionally or alternatively, memories 111b, 112b, and 113b can also operate as non-transitory computer readable storage media and can store instructions, which can cause at least one component of system 100 (e.g., one or more of processor 111, chipset 112, and network controller 113) to perform methods (e.g., operations associated with system 100) described herein.

Further, although not shown in FIG. 1, system 100 can include additional non-transitory computer readable storage media (e.g., memory) containing instructions, which (in place of or in addition to at least one of memories 111b, 112b, 113b, and 115) can cause at least one component of system 100 (e.g., one or more of processor 111, chipset 112, and network controller 113) to perform methods (e.g., operations associated with system 100) described herein.

Host 120 can have the ability to implement communication among virtual and physical components in system 100. Host 120 can host virtual machines 141 and 142. Host 120 can include one or more operating system (OS), A portion of host 120 or the entire host 120 can be included in platform hardware 110. For example, an OS associated with host 120 can be included in memory 115.

Each of virtual machines 141 and 142 can be implemented by software, hardware, or a combination of both. Each of virtual machines 141 and 142 can execute its own software programs. Such software programs can include an OS (e.g., a guest OS), applications, or other types of software. Virtual machines 141 and 142 can be implemented at host 120. Alternatively, virtual machine 141, 142, or both can be implemented outside host 120. A portion of each of virtual machines 141 and 142 or the entire virtual machine 141 or 142 can be included in platform hardware 110 (e.g., in memory 115).

Virtual switch 130 can be implemented by software. A portion of virtual switch 130 or the entire virtual switch 130 can be included in at least one component of platform hardware 110, such as in at least one of processor 111, memory 115, network controller 113, and chipset 112. As an example, virtual switch 130 can be implemented at memory 115.

System 100 includes communication paths (e.g., communication channels) 151, 152, 161, 162, and 171, which can be normal communication paths to allow communication (e.g., transmitting information) among platform hardware 110, host 120, virtual switch 130, and virtual machines 141 and 142.

Communication path 151 allows communication between virtual machine 141 and entity 109. Communication path 152 allows communication between virtual machine 142 and entity 109. Communication path 161 allows communication between virtual machine 141 and host 120. Communication path 162 allows communication between virtual machine 142 and host 120. Communication path 171 allows communication between virtual machines 141 and 142 through virtual switch 130.

System 100 can also include handover communication paths (e.g., handover communication channels) 101, 102, 103, 104, and 105, which can be created by the entities of system 100 (e.g., by one or more of platform hardware 110, host 120, virtual switch 130, and virtual machines 141 and 142).

Handover communication paths 101, 102, 103, 104, and 105 can be created at a particular time based on communication flow parameters among the entities of system 100 at that particular time. The communication flow parameters can include priority (e.g., high priority or low priority), SLA or cost of computing (or both) associated with virtual machines used in system 100, latency (e.g., low latency such as high-speed data, or high latency data such as low-speed data), or other communication flow parameters. If a particular handover communication path (one of 101, 102, 103, 104, and 105) is created and a change occurs in communication flow parameters used to create that particular handover communication path, then that handover communication path can be disabled (e.g., terminated or disconnected). Alternatively, that handover communication path can remain (e.g., may not be disabled) in system 100 even if such a change occurs.

In system 100, handover communication paths 101, 102, 103, 104, and 105 can be permanent or temporary based on the enhanced intelligence configuration information set up in the entities of system 100 (e.g., set up in platform hardware 110, host 120, virtual switch 130, and virtual machines 141 and 142).

Virtual switch 130 can set up (e.g., set up during an initialization phase) configuration information to create at least one of handover communication paths 101, 102, 103, 104, and 105. The configuration information can be based on (or can include) communication flow parameters priority and latency) described above. One or more components in platform hardware 110 can be configured to store the configuration information set up by virtual switch 130. For example, at least one of memories 111b, 112b, and 113b can be configured to store at least a portion of the configuration information set up by virtual switch 130. Alternative, one of memories 111b, 112b, and 113b can be configured to store the entire configuration information set up by virtual switch 130.

Handover communication path 101 allows virtual machine 141 and platform 110 to bypass virtual switch 130 and communicate (e.g., directly communicate) with each other through handover communication path 101 without going through virtual switch 130. Handover communication path 101 can be configured to transmit information at a higher rate than communication path 151.

handover communication path 102 allows virtual machine 141 and host 120 to bypass virtual switch 130 and communicate (e.g., directly communicate) with each other through handover communication path 102 without going through virtual switch 130. Handover communication path 102 can be arranged to transmit information at a higher rate than communication path 161.

Handover communication path 103 allows virtual machine 142 and platform 110 to bypass virtual switch 130 and communicate (e.g., directly communicate) with each other through handover communication path 103. Handover communication path 103 can be arranged to transmit information at a higher rate (e.g., higher speed) than communication path 152.

Handover communication path 104 allows virtual machine 142 and host 120 to bypass virtual switch 130 and communicate (e.g., directly communicate) with each other through handover communication path 104 without going through virtual switch 130. Handover communication path 104 can be arranged to transmit information at a higher rate than communication path 162,

Handover communication path 105 allows virtual machine 142 and virtual machine 142 to bypass virtual switch 130 and communicate directly communicate) with each other through handover communication path 105 without going through virtual switch 130. Handover communication path 105 can be arranged to transmit information at a higher rate than communication path 171.

Virtual switch 130 can be configured with enhanced intelligence, such that it is aware of active traffic flowing through system 100 and can take appropriate actions to improve operations of system 100. For example, the configuration (e.g., enhanced intelligence) may allow virtual switch 130 to handover traffics going through it to alternative communication paths that may have a relatively lower overhead, higher speed, or both. Such alternative communication paths can include communication paths 101, 102, 103, 104, and 105.

Some conventional virtual switch-based communication systems may not be configured to include or create communication paths similar to communication paths 101, 102, 103, 104, and 105. For example, some conventional virtual switch-based communication systems may be configured such that a number of network elements (e.g., software stacks in a virtual machine) are consolidated with commercial off-the-shelf (COTS) hardware. Such a configuration may generate a complex and challenging environment on network-function virtualization (NFV) platform and may prevent it from providing a low latency and low overhead communication between virtual machines in the system. A conventional virtual switch (which is a pure software implementation of Layer 2/Layer 3) in such a system may become a bottleneck in the system in some situations, and may consume more platform resources to get the data to and from the virtual machines. Although some virtual switch operations (e.g., classify/hashing) in the conventional system may be offloaded to hardware, such operations may be hardware dependent and may be unsuitable for many data types (e.g., encrypted data where information (e.g., (data or packet) fields are not plain text)

The techniques described below with respect to system 100 of FIG. 1 address the above limitations and challenges of some conventional virtual switch-based communication systems. In system 100, virtual switch 130 is configured such that it is aware of the source and destination (e.g., target) of the different flows in system 100. This allows different optimizations in system 100 to be realized in order to enhance operations of system 100. The enhancement may allow virtual switch 130 and virtual machines 141, 142. to work in conjunction with each other based on initialization of an application-programming interface (API) and create communication paths (e.g., handover communication paths 101, 102, 103, 104, and 105) based on communication flows and source and destination.

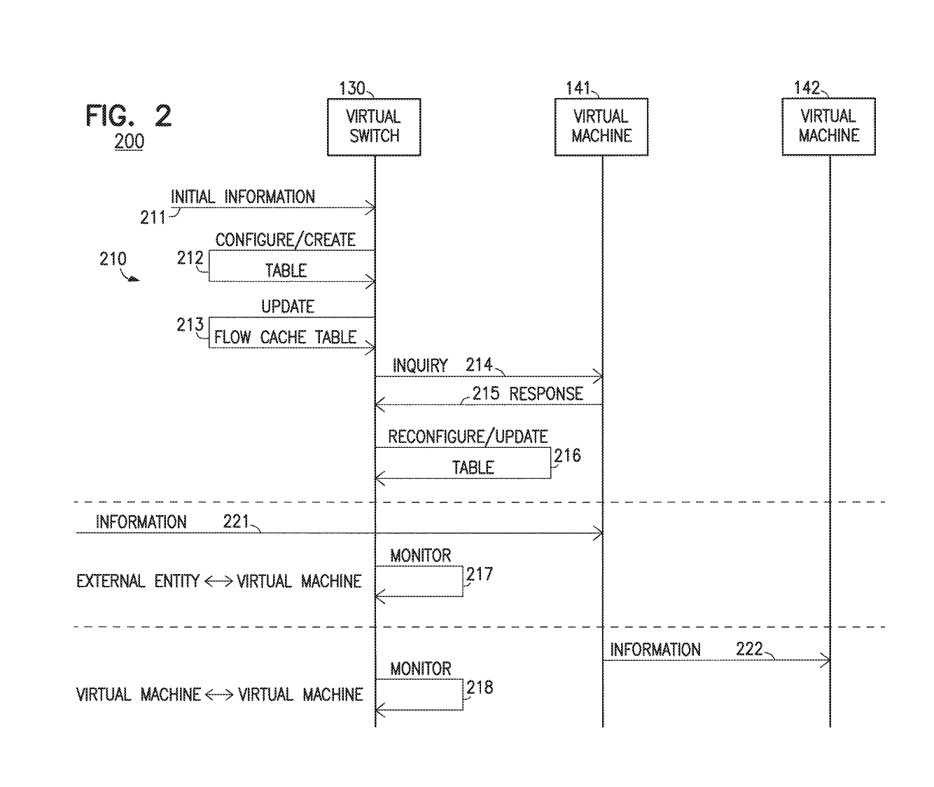

FIG. 2 is a diagram showing an algorithm 200 associated with communication flow and creation of communication paths in system 100, according to some embodiments described herein. Algorithm 200 shows enhancements to system 100 that may lead to improved communication paths, which can be created during initialization based on algorithm 200. This may reduce involvement of virtual switch 130 in critical communication paths (e.g., handover communication paths 101, 102, 103, 104, and 105) in system 100, leading to low latency and improved reliability in system 100.

Without the enhancements included in algorithm 200 described herein, communication flow among components in a conventional virtual switch-based communication system may be more complex. This may cause a virtual switch in the conventional system to become bottleneck in the system.

As shown in FIG. 2, algorithm 200 includes an initialization phase 210 to set up communication paths (e.g., handover communication paths 101, 102, 103, 104, and 105) for subsequent communication among entities of system 100 after the initialization. Algorithm 200 can be implemented by software, hardware, firtnware, or any combination of software, hardware, and firmware.

In some arrangements of system 100, at least a portion of algorithm 200 (e.g., part of algorithm 200 or the entire algorithm 200) can be included in platform hardware 110, such as included in the processor 111, chipset 112, network controller 113, functional unit 114 (e.g., accelerator), memory 115, or any combination of these components 110.

As shown in FIG. 2, during initialization phase 210, virtual switch 130 and virtual machines 141 and 142 can perform operations 211 through 216. Initialization phase 210 can be performed for each given communication flow in system 100. Communication flow parameters (e.g., priority and latency) associated with one communication flow can be different from another communication flow.

In operation 211, virtual switch 130 can receive an initial information (e.g., packets, frames, or other information) of a given communication flow. The initial information can be received on a control path of virtual switch 130 (FIG. 1). In operation 212, virtual switch 130 can configure and create a flow table entry based on information in the initial information. In operation 213, virtual switch 130 can update a flow cache table based on information in the initial information. Virtual switch 130 can transmit information to virtual machine 141 through a normal communication path (e.g., communication path 151 or 161 in FIG. 1) based on the flow table entry in operation 212.

In operation 214, virtual switch 130 can send an inquiry to virtual machine 411. The inquiry can include priority information or latency information (or both) associated with a particular communication flow. For example, in the inquiry, virtual switch 130 may seek a response from virtual machine 141 that indicates whether a priority associated with a particular communication flow is a high or low priority communication flow, and whether latency associated with a particular communication flow is a high or low latency communication flow.

The information in the inquiry in operation 214 can also involve the capability of virtual machine 411. For example, in the inquiry, virtual switch 130 may seek a response from virtual machine 141 that indicates whether a direct link (e.g., a handover communication path) can be created from source to destination for a particular communication flow.

In operation 215, virtual machine 411 can send a response to virtual switch 130 in response to the inquiry from virtual switch 130. The response can include information indicating the priority and latency associated with a particular communication. The response can also include information indicating whether a direct link can be created from source to destination.

Handover communication paths (e.g., 102, 104, and 105) may or may not be created, depending on the information in the response. For example, the handover communication paths (e.g., 102, 104, or both) between host 120 and one or both of virtual machines 411 and 412 can be created if the information in the response indicates that a direct link (e.g., direct communication path) can be created from source to destination. The handover communication path (e.g., 105) between virtual machines 411 and 412 can be created if the information in the response indicates that a direct link can be created from source to destination. One or more handover communication paths 102, 104, or both) cannot be created if the information in the response indicates that a direct link cannot be created from source to destination.

In operation 216, virtual switch 130 can reconfigure and update the flow table entry based on the response from virtual machine 141. For example, virtual switch 130 can transmit information to virtual machine 141 through a direct communication path (e.g., handover communication path 101 or 102 in FIG. 1) based on reconfiguration and update of the flow table entry based on the response from virtual machine 141.

Configuration information set up by virtual switch 130 can be stored in at least one of memory 111b, 112b, and 113b. Alternatively, the entire configuration information set up by virtual switch 130 can be stored in one of memory 111b, 112b, and 113b.

The above description describes inquiry and response operations between virtual switch 130 and virtual machine 141 to set up communication paths associated with virtual machine 141. However, similar inquiry and response operations can be performed between virtual switch 130 and virtual machine 142 to set up communication paths associated with virtual machine 142.

In some situations in algorithm 200, it may become more complex when the data is coming from the external network (e.g., from entity 109). In such situations, a para-virtualization I/O model can be used in to create point-to-point communication between I/O devices and virtual machines 141 and 142.

After creation of one or more handover communication paths as described above, information can be transmitted directly from source to destination on the handover communication path. For example, as shown in FIG. 2, information 221 can flow directly from entity 109 to virtual machine 141 (e.g., flow through handover communication path 101 of FIG. 1) without entering virtual switch 130 (e.g., bypassing virtual switch 130). In another example, information 222 (e.g., from virtual machine 141) can flow directly from virtual machine 141 to virtual machine 142 (e.g., flow through handover communication path 105 of FIG. 1) without entering virtual switch 130 (e.g., bypassing virtual switch 130).

Thus, in the example above, virtual switch 130 can skip (does not perform) some of the functions associated with transmitting information 221 that it may normally perform (perform if the direct communication path was not created). For example, virtual switch 130 may skip computing hash and looking up the destination associated with information 221. Similarly, virtual switch 130 can skip (does not perform) some of the functions associated with transmitting information 222 it may normally perform (perform if the direct communication path was not created). For example, virtual switch 130 may skip computing hash and looking up the destination associated with information 222.

As shown in FIG. 2, in operation 217, virtual switch 130 can monitor communication flow associated with the handover communication path between entity 109 and virtual machine 141 and take appropriate actions based on the monitor (without interfering with the communication flow on the handover communication path between the entity and virtual machine 141). Similarly, in operation 218, virtual switch 130 can monitor communication flow associated with handover communication path between virtual machines 141 and 142 and take appropriate actions based on the monitor (without interfering with the communication flow on handover communication path between virtual machines 141 and 142).

As an example, in each of operations 217 and 218, virtual switch 130 can monitor the expiry of the communication flow and the status (e.g., changed or unchanged in the status) of the priority of the communication flow. Based on the monitor, the handover communication paths can remain in system 100 or alternatively can be disabled (e.g., terminated or disconnected).

For example, a particular handover communication path can remain (e.g., may not be disabled) in system 100 if the communication flow associated with that particular handover communication path is not expired. The particular handover communication path can be disabled if the communication flow associated with that particular handover communication path is expired. In an alternative arrangement (e.g., configuration), a particular handover communication path can remain in system 100 even if the communication flow associated with that particular handover communication path is expired. In such an alternative arrangement, the particular handover communication (which remains in the system 100) path is a pre-existing handover communication from the point of view of future communication flow operation in system 100.

In another example, a particular handover communication path may remain (e.g., may not be disabled) in system 100 if the priority of the communication flow associated with that particular handover communication path is unchanged (e.g., remains at a high (e.g., critical) priority). The particular handover communication path can be disabled if the priority of the communication flow associated with that particular handover communication path is changed (e.g., from a high (e.g., critical) priority to a low (e.g., non-critical) priority. In an alternative arrangement (e.g., configuration), a particular handover communication path can remain in system 100 even if the priority of the communication flow associated with that particular handover communication path is changed. In such an alternative arrangement, the particular handover communication (which remains in the system 100) path is a pre-existing handover communication from the point of view of future communication flow operation in system 100.

As shown in FIG. 1, although handover communication paths can be created, other communication paths (e.g., non-critical communication paths), such as communication paths 151, 152, 161, 162, and 171 may still go through virtual switch 130.

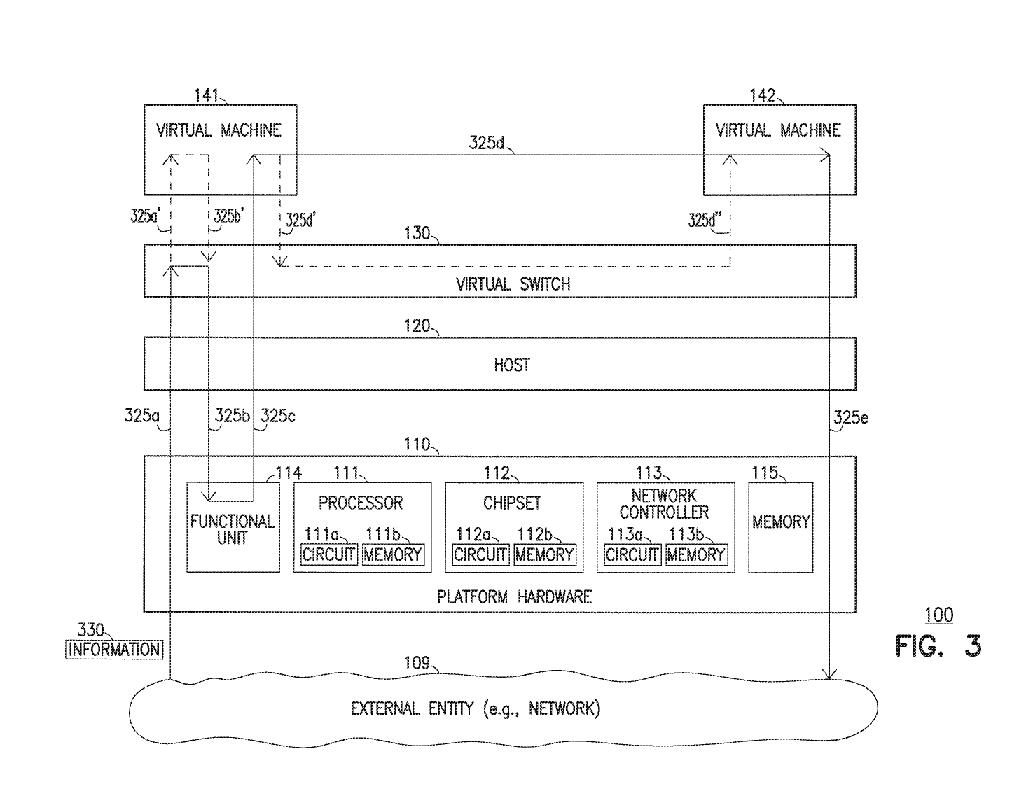

FIG. 3 shows a block diagram of system 100 of FIG. 1 including an example of reduced communication paths, according to some embodiments described herein. Shown in FIG. 3 is an example where information (e.g., packets) 330 can be sent to platform hardware 110 (e.g., to one of circuits 111a, 113a, and 112a) from entity 109 (e.g., from a network). FIG. 3 shows two different flow paths of different lengths on which information 330 can be transmitted. One flow path (e.g., primary flow path) includes paths (solid lines) 325a, 325b, 325c, 325d, and 325e. Another flow path (e.g., alternative flow path) includes paths (all of the paths shown in FIG. 3 except path 325d) 325a, 325a′, 325b′, 325b, 325c, 325d′, 325d″, and 325e. Thus, as shown in FIG. 3, the alternative flow path is longer than the primary flow path.

The two different flow paths of information 330 are associated with a situation where an operation (e.g., offload operation) is performed (e.g., performed by functional unit 114) on information 330 after it is received at platform hardware 110. Examples of such an operation (which can be performed by functional unit 114) includes encryption, decryption, compression, L1 modulation and demodulation (e.g., Fast Fourier Transform (FFT), inverse FFT, etc.), or other operations. Depending on whether the enhanced techniques described herein are used, information 330 can be transmitted on one of the two flow paths shown in FIG. 3. As described below, the flow path (e.g., primary path) of information 330 is shorter (compared with the alternative path) if enhanced techniques are used. The flow path (e.g., alternative path) of information 330 is longer (compared with the primary path) if enhanced techniques are not used.

The following description gives an example where the techniques described herein are not used. In FIG. 3, after information 330 is received (e.g., received by circuit 111a, 113a, 112a, or other physical components of platform hardware 110), information 330 is sent to virtual machine 141 (through paths 325a and 325a′), then virtual machine 141 sends information 330 to functional unit 114 (through paths 325b and 325b′). Functional unit 114 performs an operation (e.g., offload operation) on information 330. After the operation is completed, functional unit 114 sends the information (e.g., resulting information based on information 330, such as encrypted, decrypted, compressed information) back to virtual machine 141 (through path 325c). Virtual machine 141 sends the information to virtual switch 130 (through path 325d′). Virtual switch 130 sends the information 330 to virtual machine 142 (through path 325d″). Virtual machine 142 sends the information to entity 109 (through path 325e). Without using the techniques described herein, the flow paths of information 330 in this example may be complicated and may incur unwanted overhead because of data copy, cache flush, and so forth.

The following description gives an example where the techniques described herein are used. In the described techniques, virtual machine 130 can be configured, such that it can optimize (e.g., reduce) part of the flow path of information 330. For example, as shown in FIG. 3, when the information 330 is received at platform hardware 110, it can be sent to virtual switch 130 and then from virtual switch 130 directly to functional unit 114 (through paths 325a and 325b) instead of going to virtual machine 141 (through path 325a′) and then getting resubmitted (through path 325c). Thus, information 330 can be sent from virtual switch 130 to functional unit 114 for an offload operation on information 330 (e.g., to generate resulting information, such as encrypted, decrypted, compressed information) without sending information 330 to virtual machine 141 before the operation is performed on information 330.

After the operation is completed, functional unit 114 sends the information to virtual machine 141 (through path 325c). Virtual machine 141 can process the information and send it directly to virtual switch 142 (through path 325d. Path 325c can include handover communication path 105 (described above). Thus, as shown in the example of FIG. 3, in some situations (e.g,, when offload operation is performed), the flow path of information in system 100 may be improved (e.g., reduced).

Thus, as described above with reference to FIG. 1 through FIG. 3, the described techniques may improve operations of a virtual switch-based communication system, such as system 100. The improvements include low latency, high throughput, and reliable communication infrastructure on the NFV platform, and lower impact on the performance of the workload because of lesser data copy and cache trashing side effects. The flow of the traffic is in the control of the workloads (which receive and process the flows) rather than all the flow based on intelligence on the platform. The virtual switch (e.g., virtual switch 130) is not a bottleneck when the number of flows in the system increases. Intelligent APIs developed by the described techniques allow the virtual switch to use platform resources efficiently for switching,

Virtual machine 141 can be configured to determine whether a particular information packet from entity 109 can be sent from virtual switch 130 to functional unit 114 instead of sending from virtual switch 130 to virtual machine 141 and then sending from virtual machine 141 to functional unit 114. Virtual machine 141 and virtual switch 130 can be configured to communicate with each other to optimize the flow path of information (e.g., information 330) transmitted in the system in some situations (e.g., in a situation where an operation (e.g., offload operation) is performed. For example, virtual machine 141 can send (e.g., during an initialization) configuration information (e.g., any combination of configuration packet and API) to virtual switch 130 regarding a type of information (e.g., information where an offload operation is to be performed on the information). Based on this configuration information, if virtual switch 130 receives such type of information (e.g., information 330) intended for virtual machine 141, virtual switch 130 can send that information to functional unit 114 for an operation to be performed on the information without sending it to virtual machine 141 before such an operation is performed.

The illustrations of the apparatuses (e.g., system 100) and methods (e.g., operations of system 100 including algorithm 200) described above are intended to provide a general understanding of the structure of different embodiments and are not intended to provide a complete description of all the elements and features of an apparatus that might make use of the structures described herein.

The apparatuses described above can include or be included in high-speed computers, communication and signal processing circuitry, single or multi-processor modules, single or multiple embedded processors, multi-core processors, message information switches, and application-specific modules including multilayer, multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitor, blood pressure monitor, etc.), set top boxes, and others.

As used in this application and in the claims, a list of items joined by the term “at least one of” can mean any combination of the listed terms. For example, the phrase “at least one of A, B and C” can mean A; B; C; A and B; A and C; B and C; or A, B and C.

Additional Notes and Examples

Example 1 includes subject matter (such as a device, an electronic apparatus (e.g., circuit, electronic system, or both), or a machine) including a circuit to receive information for transmitting to at least one of a first virtual machine and a second virtual machine through a virtual switch, and a memory to store configuration information set up by the virtual switch to allow the first virtual machine to bypass the virtual switch and communicate with at least one of the second virtual machine and a host.

In Example 2, the subject matter of Example 1 may optionally include, wherein the virtual switch is configured to transmit information from the first virtual machine to an external entity through the virtual switch, and configured to allow the first virtual machine to bypass the virtual switch and communicate with the external entity.

In Example 3, the subject matter of Example 1 or 2. may optionally include, wherein the virtual switch is configured to transmit information from the first virtual machine to the second virtual machine through a first communication path through the virtual switch, and to set up the configuration information to allow the first virtual machine to bypass the virtual switch and communicate with the second virtual machine through a second communication path, the first and second communication paths configured to transmit information at different rates.

In Example 4, the subject matter of Example 1 may optionally include, wherein the virtual switch is configured to transmit information from the first virtual machine to the host through a third communication path through the virtual switch, and to set up the configuration information to allow the first virtual machine to bypass the virtual switch and communicate with the host through a fourth communication path, the third and fourth communication paths configured to transmit information at different rates.

In Example 5, the subject matter of Example 1 or 2 may optionally include, wherein the virtual switch is configured to receive first information from the circuit and send the first information to a function unit for an offload operation to generate second information without sending the first information to the first virtual machine, and to send the second information to the first virtual machine after the offload operation is completed.

In Example 6, the subject matter of Example 1 may optionally include, wherein the offload operation includes at least one of encryption, decryption, and compression operations.

In Example 7, the subject matter of Example 1 or 2 may optionally include, wherein the virtual switch is configured to monitor communication flow associated with a communication path directly coupled between the first and second. virtual machines in order to determine whether to disable the communication path.

In Example 8, the subject matter of Example 1 or 2 may optionally include, wherein the virtual switch is configured to monitor communication flow associated with a communication path directly coupled between the first virtual machine and an external entity in order to determine whether to disable the communication path.

In Example 9, the subject matter of Example 1 may optionally include, wherein the apparatus comprises a processor, and the circuit is included in the processor.

in Example 10, the subject matter of Example 1 may optionally include, wherein at least a portion of the memory is included in the processor.

Example 11 includes subject matter (such as a device, an electronic apparatus (e.g., circuit, electronic system, or both), or a machine) including a network controller to receive information for transmitting to at least one of a first virtual machine and a second virtual machine through at least one first communication path through a virtual switch, and a memory to store configuration information set up by the virtual switch to allow the first virtual machine to bypass the virtual switch and communicate with at least one of the second virtual machine and a host through at least one second communication path.

In Example 12, the subject matter of Example 11 may optionally include, wherein at least a portion of the memory is included in the network controller.

In Example 13, the subject matter of Example 11 may optionally include, wherein the virtual switch is configured to disable the second communication path if a parameter associated with a flow of communication on the second communication path is expired.

In Example 14, the subject matter of Example 11 may optionally include, wherein the virtual switch is configured to disable the second communication path if a parameter associated with a flow of communication on the second communication path is changed.

in Example 15, the subject matter of Example 11 may optionally include, wherein the virtual switch is configured to send an inquiry to the first virtual machine, the inquiry including information about whether to create a direct communication path from a source to a destination.

In Example 16, the subject matter of Example 11 may optionally include, wherein the virtual switch is configured to update a flow table entry based on a response to the inquiry sent to the virtual switch from the first virtual machine.

In Example 17, the subject matter of Example 11 may optionally include, wherein the virtual switch is configured to skip computing hash and looking up table associated with information transmitted from the first virtual machine to the second virtual machine.

Example 18 includes subject matter (such as a method of operating device, an electronic apparatus (e.g., circuit, electronic system, or both), or a machine) including configuring a virtual switch for transmitting information from a circuit to at least one of a first virtual machine and a second virtual machine through the virtual switch, and configuring the virtual switch for transmitting information directly from the first virtual machine to at least one of the second virtual machine and a host, bypassing the virtual switch, wherein configuring the virtual switch is performed by at least one of a processor, a chipset, and a network controller of a platform hardware.

in Example 19, the subject matter of Example 18 may optionally include, further comprising configuring the virtual switch for transmitting information between a network and at least one of the first and second virtual machines without transmitting the information through the virtual switch.

In Example 20, the subject matter of Example 18 may optionally include, further comprising sending first information from a circuit to the virtual switch, sending the first information from the virtual switch to a functional unit for an offload operation on the first information to generate second information without sending the first information to the first virtual machine before the offload operation is performed, and sending the second information from the functional unit to the first virtual machine through the virtual switch.

In Example 21, the subject matter of any of Examples 18-20 may optionally include, wherein at least one of the first and second virtual machines is implemented at the host.

In Example 22, the subject matter of any of Examples 18-20 may optionally include, wherein the virtual switch is implemented at the host.

In Example 23, the subject matter of any of Examples 18-20 may optionally include, wherein at least a portion of the host is included in a memory.

Example 24 includes subject matter including non-transitory computer readable storage medium containing instructions, which cause a processing unit to configure a virtual switch for transmitting information to at least one of a first virtual machine and a second virtual machine through the virtual switch, and configure the virtual switch for transmitting information directly from the first virtual machine to at least one of the second virtual machine and a host bypassing the virtual switch.

In Example 25, the subject matter of Example 24 may optionally include, wherein the instructions further cause at least one component of a system to configure the virtual switch for transmitting information between a network and at least one of the first and second virtual machines without transmitting the information through the virtual switch.

in Example 26, the subject matter of Example 24 or 25 may optionally include, wherein the instructions further cause at least one component of a system to send first information from a circuit to the virtual switch, send the first information from the virtual switch to a functional unit for an offload operation on the first information to generate second information without sending the first information to the first virtual machine before the offload operation is performed, and send the second information from the functional unit to the first virtual machine through the virtual switch.

Example 27 includes subject matter (such as a device, an electronic apparatus (e.g., circuit, electronic system, or both), or machine) including means for performing any of the methods of claims 18-23.

The subject matter of Example 1 through Example 27 may be combined in any combination.

The above description and the drawings illustrate some embodiments to enable those skilled in the art to practice the embodiments of the invention. Other embodiments may incorporate structural, logical, electrical, process, and other changes. Examples merely typify possible variations. Portions and features of some embodiments may be included in, or substituted for, those of other embodiments. Many other embodiments will be apparent to those of skill in the art upon reading and understanding the above description. Therefore, the scope of various embodiments is determined by the appended claims, along with the full range of equivalents to which such claims are entitled.

The Abstract is provided to comply with 37 C.F.R. Section 1.72(b) requiting an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a circuit to receive information for transmitting to at least one of a first virtual machine and a second virtual machine through a virtual switch; and
a memory to store configuration information set up by the virtual switch to allow the first virtual machine to bypass the virtual switch and communicate with at least one of the second virtual machine and a host.

2. The apparatus of claim 1, wherein the virtual switch is configured to transmit information from the first virtual machine to an external entity through the virtual switch, and configured to allow the first virtual machine to bypass the virtual switch and communicate with the external entity.

3. The apparatus of claim 1, wherein the virtual switch is configured to transmit information from the first virtual machine to the second virtual machine through a first communication path through the virtual switch, and to set up the configuration information to allow the first virtual machine to bypass the virtual switch and communicate with the second virtual machine through a second communication path, the first and second communication paths configured to transmit information at different rates.

4. The apparatus of claim 3, wherein the virtual switch is configured to transmit information from the first virtual machine to the host through a third communication path through the virtual switch, and to set up the configuration information to allow the first virtual machine to bypass the virtual switch and communicate with the host through a fourth communication path, the third and fourth communication paths configured to transmit information at different rates.

5. The apparatus of claim 1, wherein the virtual switch is configured to receive first information from the circuit and send the first information to a function unit for an offload operation to generate second information without sending the first information to the first virtual machine, and to send the second information to the first virtual machine after the offload operation is completed.

6. The apparatus of claim 5, wherein the offload operation includes at least one of encryption, decryption, and compression operations.

7. The apparatus of claim 1, wherein the virtual switch is configured to monitor communication flow associated with a communication path directly coupled between the first and second virtual machines in order to determine whether to disable the communication path.

8. The apparatus of claim 1, wherein the virtual switch is configured to monitor communication flow associated with a communication path directly coupled between the first virtual machine and an external entity in order to determine whether to disable the communication path.

9. The apparatus of claim 1, wherein the apparatus comprises a processor, and the circuit is included in the processor.

10. The apparatus of claim 9. wherein at least a portion of the memory is included in the processor.

11. An apparatus comprising:
a network controller to receive information for transmitting to at least one of a first virtual machine and a second virtual machine through at least one first communication path through a virtual switch; and
a memory to store configuration information set up by the virtual switch to allow the first virtual machine to bypass the virtual switch and communicate with at least one of the second virtual machine and a host through at least one second communication path.

12. The apparatus of claim 11, wherein at least a portion of the memory is included in the network controller.

13. The apparatus of claim 11, wherein the virtual switch is configured to disable the second communication path if a parameter associated with a flow of communication on the second communication path is expired.

14. The apparatus of claim 11, wherein the virtual switch is configured to disable the second communication path if a parameter associated with a flow of communication on the second communication path is changed.

15. The apparatus of claim 11, wherein the virtual switch is configured to send an inquiry to the first virtual machine, the inquiry including information about whether to create a direct communication path from a source to a destination.

16. The apparatus of claim 15, wherein the virtual switch is configured to update a flow table entry based on a response to the inquiry sent to the virtual switch from the first virtual machine.

17. The apparatus of claim 11, wherein the virtual switch is configured to skip computing hash and looking up table associated with information transmitted from the first virtual machine to the second virtual machine.

18. A method comprising:
configuring a virtual switch for transmitting information to at least one of a first virtual machine and a second virtual machine through the virtual switch; and
configuring the virtual switch for transmitting information directly from the first virtual machine to at least one of the second virtual machine and a host, bypassing the virtual switch, wherein configuring the virtual switch is performed by at least one of a processor, a chipset, and a network controller of a platform hardware.

19. The method of claim 18, further comprising:
configuring the virtual switch for transmitting information between a network and at least one of the first and second virtual machines without transmitting the information through the virtual switch.

20. The method of claim 18, further comprising:
sending first information from a circuit to the virtual switch;
sending the first information from the virtual switch to a functional unit for an offload operation on the first information to generate second information without sending the first information to the first virtual machine before the offload operation is performed; and
sending the second information from the functional unit to the first virtual machine through the virtual switch.

21. The method of claim 18, wherein at least one of the first and second virtual machines is implemented at the host.

22. The method of claim 21, wherein the virtual switch is implemented at the host.

23. The method of claim 21, wherein at least a portion of the host is included in a memory.

24. A non-transitory computer readable storage medium containing instructions, which cause a processing unit to:
configure a virtual switch for transmitting information to at least one of a first virtual machine and a second virtual machine through the virtual switch; and
configure the virtual switch for transmitting information directly from the first virtual machine to at least one of the second virtual machine and a host bypassing the virtual switch.

25. The non-transitory computer readable storage medium of claim 24, wherein the instructions further cause at least one component of a system to configure the virtual switch for transmitting information between a network and at least one of the first and second virtual machines without transmitting the information through the virtual switch.

26. The non-transitory computer readable storage medium of claim 24, wherein the instructions further cause at least one component of a system to:
send first information from a circuit to the virtual switch;
send the first information from the virtual switch to a functional unit for an offload operation on the first information to generate second information without sending the first information to the first virtual machine before the offload operation is performed; and
send the second information from the functional unit to the first virtual machine through the virtual switch.
